(19) United States
(12) Patent Application Publication
(10) Pub. No.: US 2017/0219793 A1
(43) Pub. Date: Aug. 3, 2017

(54) Sealed module with glue guiding features and method for making same

(71) Applicants: Martin Lander Olesen, Farum (DK); Jesper Falden Offersgaard, Farum (DK)

(72) Inventors: Martin Lander Olesen, Farum (DK); Jesper Falden Offersgaard, Farum (DK)

(73) Assignee: AAC Technologies Pte. Ltd., Singapore (SG)

(21) Appl. No.: 15/008,560

(22) Filed: Jan. 28, 2016

(51) Int. Cl. G02B 7/02; B32B 37/02; B29D 11/00; B32B 38/00; B32B 41/00; B32B 37/12; B32B 37/18

(52) U.S. Cl. CPC G02B 7/02; B32B 37/1292; B32B 37/02; B32B 37/18; B32B 38/0008; B32B 41/00; B29D 11/00413; B32B 2037/1253; B32B 2307/40; B32B 2310/0831; B32B 2551/00; B29K 2995/0018

(57) ABSTRACT

A sealed module is provided in the present disclosure. The sealed module includes a first substrate with a lens unit and an adhesive geometry formed around the lens unit, a second substrate stacked onto the first substrate, and a sealing wall for sealing the first substrate with the second substrate to form a closed cavity. The lens unit is located in the closed cavity, and the adhesive geometry serves as an adhesive barrier. The adhesive geometry includes glue guiding features for controlling a track of adhesive glue during a stacking process between the first substrate and the second substrate. The present disclosure further provides a method for making a sealed module.

### FIELD OF THE DISCLOSURE

The present disclosure relates to sealing technologies, and more particularly, to a method for making a sealed module with glue guiding features and a sealed module obtained by the method.

### BACKGROUND

A related sealed module generally includes a bottom wafer and a top wafer stacked onto the bottom wafer; typically, the top wafer is sealed to the bottom wafer by adhesive walls provided on the bottom wafer. In a sealing process, the top wafer is lowered towards the bottom wafer, and when the top wafer gets in contact with the adhesive walls, a closed cavity filled with air is formed between the top wafer and the bottom wafer. In addition, an air pressure inside the closed cavity increases as the top wafer moves closer and closer to the bottom wafer. However, the adhesive walls may not be capable of withstanding the increased air pressure inside the closed cavity; in this circumstance, the adhesive walls may suffer exploding and be destroyed. Therefore, a yield of sealed modules is very low and unpredictable.

Therefore, it is desired to provide a method for making a sealed module which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of a sealed module according to an embodiment of the present disclosure;

FIG. 2 is a planar view of a first substrate of the sealed module of FIG. 1;

FIGS. 3A-3F schematically illustrates a method for making a sealed module according to an embodiment of the present disclosure.

### DETAILED DESCRIPTION

The present disclosure will be described in detail below with reference to the attached drawings and the embodiment thereof.

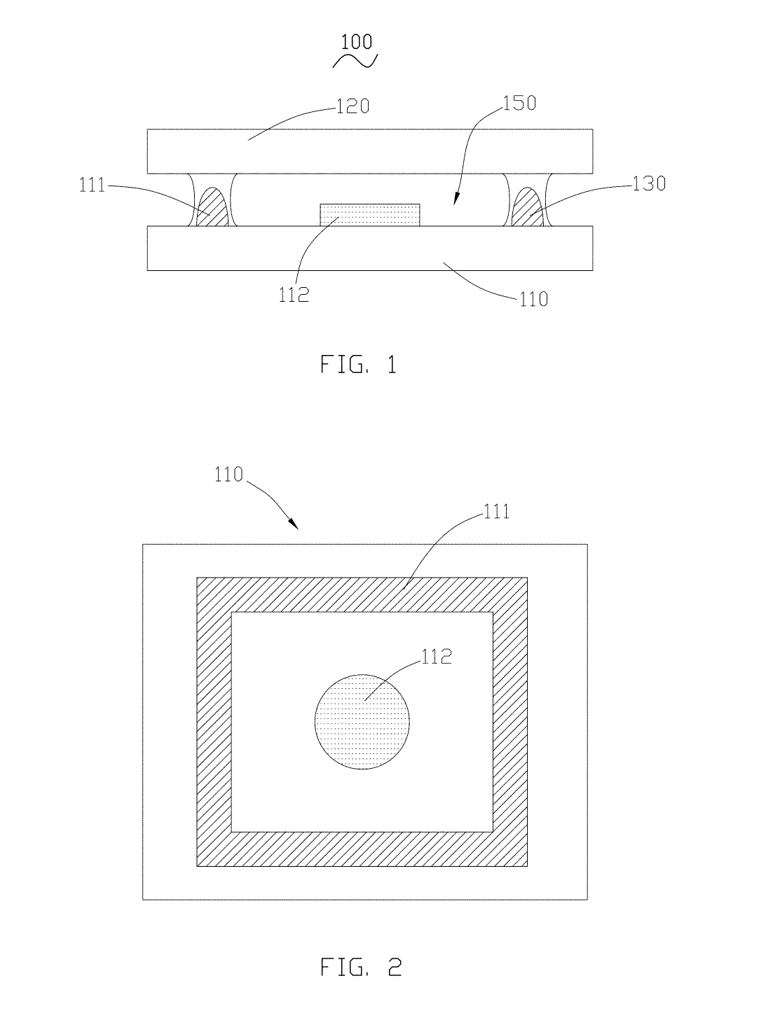

Referring to FIG. 1, a sealed module 100 according to an embodiment of the present disclosure is shown. The sealed module 100 includes a first substrate 110, a second substrate 120, and a sealing wall 130; the second substrate 120 is stacked and sealed onto the first substrate 110 by the sealing wall 130.

The first substrate 110 may be a bottom substrate which can be obtained from a bottom wafer by a slicing process, and includes a lens unit 112 arranged on a main central region thereof. The second substrate 120 may be a top substrate which can be obtained from a top wafer by the slicing process. The sealing wall 130 is formed around the lens unit 112, and is sandwiched between the first substrate 110 and the second substrate 120 for realizing adhesion between the first substrate 110 and the second substrate 120. The second substrate 120, the first substrate 110 and the sealing wall 130 cooperatively form a closed cavity 150, and the lens unit 112 is received in the closed cavity 150 and faces the second substrate 120.

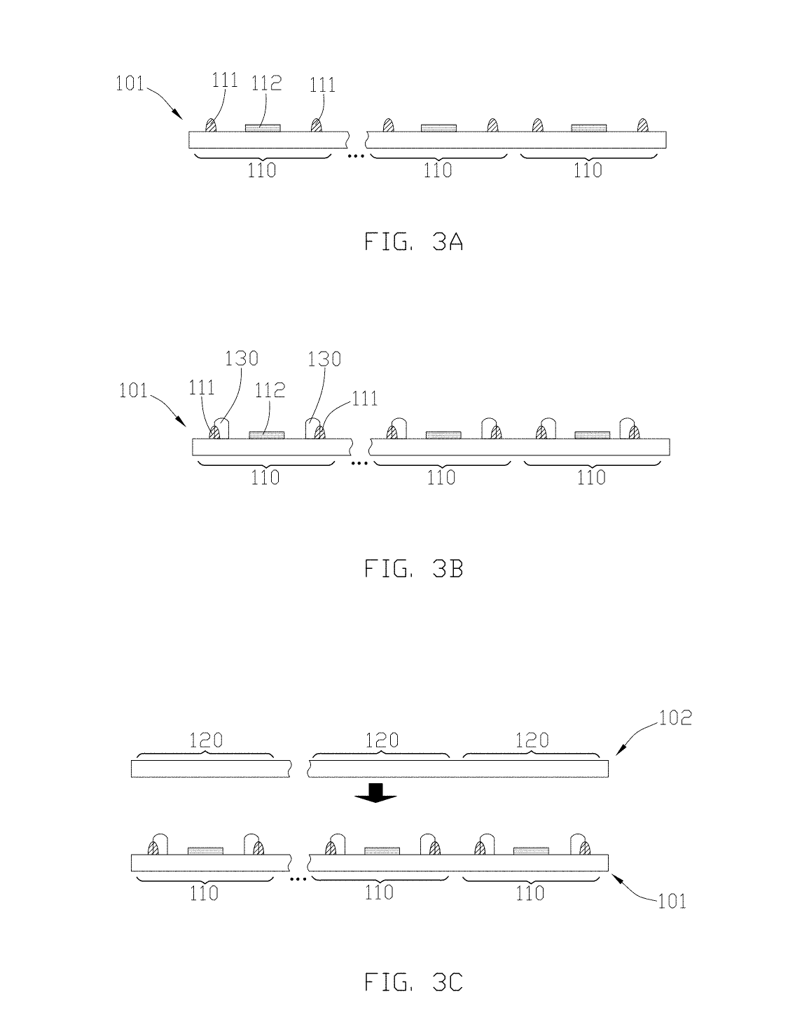

Referring also to FIG. 2, in the present embodiment, the first substrate 110 includes an adhesive geometry 111 around the lens unit 112; the adhesive geometry 111 may serve as an adhesive barrier, and may have a round-ring shape or rectangular-ring shape. Moreover, in practice, the adhesive geometry 111 may be pre-molded on the first substrate 110 by molding process, or be made of cured adhesive material by dispensing and curing process.

The adhesive geometry 111 is formed with glue guiding features; the glue guiding features may be convex features or concave features. For example, the adhesive geometry 111 may include a plurality of lines with convex or concave cross section, and the lines are connected end to end to surround the lens unit 112. In the present embodiment, the adhesive geometry 111 is configured for controlling a track of adhesive glue during a stacking process between the first substrate 110 and the second substrate 120, so as to ensure an air pressure inside the closed cavity 150 not to exceed an exploding threshold. Moreover, the adhesive glue serves as the sealing wall 130 after being cured, and the adhesive geometry 111 is located within and wrapped up by the sealing wall 130 after the second substrate 120 is stacked and sealed to the first substrate 110.

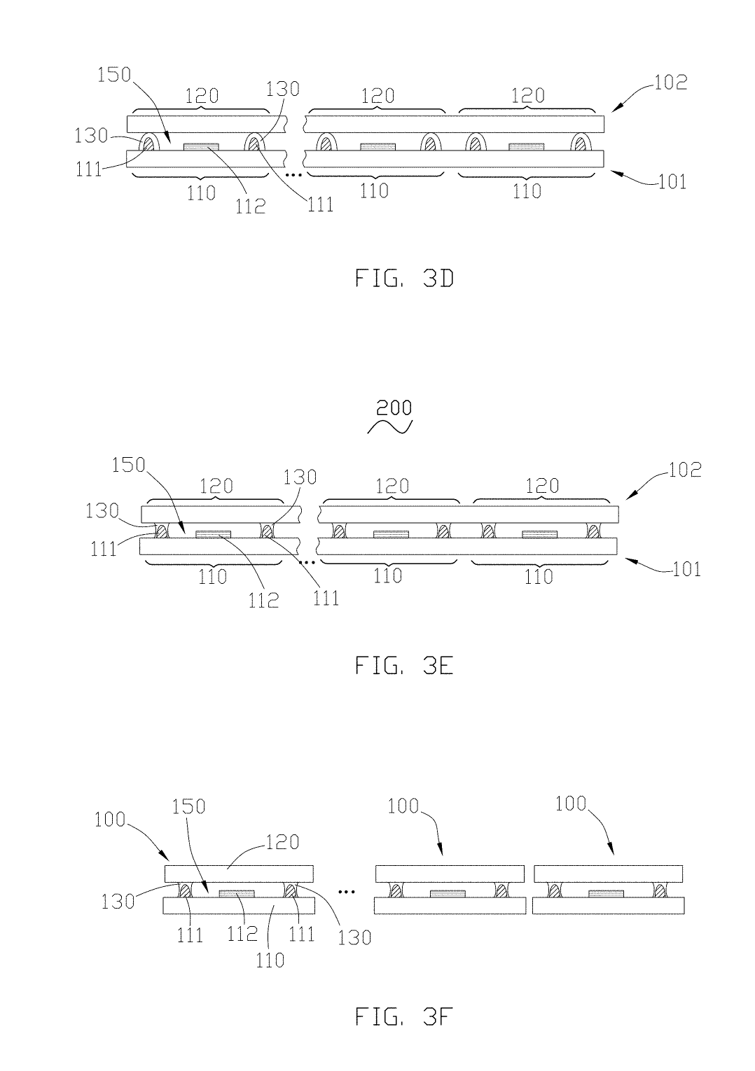

FIGS. 3A-3F schematically illustrates a method for making the sealed module 100 according to an embodiment of the present disclosure. The method mainly includes the following steps:

Steps S1, a bottom wafer 101 having adhesive geometries 111 is provided;

As illustrate in FIG. 3A, the bottom wafer 101 may be divided into a plurality of bottom wafer units 110, each of the bottom wafer units 110 serves as a first substrate of the sealed module 100 after being sliced. The bottom wafer 101 includes a plurality of lens units 112 is arranged on the bottom wafer 101 in a matrix manner, and each of the lens units 112 is located on a main central region of a corresponding bottom wafer unit 110.

Moreover, a plurality of adhesive geometries 111 are formed on the bottom wafer 101, each adhesive geometry 111 corresponds to a respective bottom wafer unit 110, and is formed around the lens unit 112 on the bottom wafer unit 110. The adhesive geometry 111 serves as adhesive barrier, and includes glue guiding features for controlling a track of adhesive glue. The glue guiding features may be convex features or concave features; for example, the adhesive geometry 111 may have a convex or concave cross section.

In the present disclosure, the adhesive geometries 111 may be formed by two optional approaches, namely, a molding approach and a dispensing approach. In the molding approach, the adhesive geometries 111 are pre-molded on the bottom wafer 101 around every lens units 112 by molding process. In the dispensing approach, the adhesive geometries 111 are firstly dispensed onto the bottom wafer 101 around every lens units 112, and then are cured by using ultraviolet (UV) flood exposure.

Step S2, adhesive glue 130 is dispensed onto the bottom wafer 101 inside every adhesive geometry 111 and around every lens unit 112.

Referring to FIG. 3B, in step S2, adhesive glue 130 is provided and respectively dispensed onto the bottom wafer units 110 of the bottom wafer 101; in particular, the adhesive glue 130 is dispensed inside every adhesive geometry 111 and around every lens unit 112 of the bottom wafer 101. For example, in the present embodiment, as illustrated in FIG. 3B, the adhesive glue 130 may be dispensed adjacent to the adhesive geometries 111 and partly cover the adhesive geometries 111.

Step S3, a top wafer 102 is provided and aligned with the bottom wafer 101.

As illustrate in FIG. 3C, the top wafer 102 as provided in step S3 may be divided into a plurality of top wafer units 120, each of the top wafer units 120 corresponds to a respective bottom wafer unit 110 of the bottom wafer 101, and has a size and a shape substantially coincide with the bottom wafer unit 110. Moreover, each of the top wafer units 120 serves as a second substrate of the sealed module 100 after being sliced. In step S3, the top wafer 102 is further moved above and faces the bottom wafer 101, such that each of the top wafer units 120 is aligned with a corresponding one of the bottom wafer units 110 respectively.

Step S4, the top wafer 102 is moved towards and stacked onto the bottom wafer 101 and the adhesive glue 130 moves over ridges of the adhesive geometries 111.

Referring to FIG. 3D, in step S4, after being aligned with the bottom wafer 101, the top wafer 102 can be moved to the bottom wafer 101 to implement a stacking process. Specifically, the top wafer 102 is lowered towards the bottom wafer 101, and as such, the top wafer 102, the bottom wafer 101 and the adhesive glue 130 dispensed on the bottom wafer 101 cooperatively form a plurality of closed cavities 150. In particular, each of the closed cavities 150 is located between a pair of top wafer unit 120 and bottom wafer unit 110. During the stacking process, the top wafer unit 120 compresses air in a corresponding closed cavity 150, and accordingly an air pressure inside the closed cavity 150 increases. The increasing air pressure inside the closed cavity 150 further causes the adhesive glue 130 to move over a ridge of the adhesive geometry 111 on the bottom wafer unit 110.

As described above, the adhesive geometry 111 includes glue guiding features such as convex features or concave features, the glue guiding features locally increase a surface area of the adhesive geometry 111, and thereby locally decreasing surface energy of the adhesive geometry 111. Accordingly, the adhesive glue 130 is attracted to move to the glue guiding features of the adhesive geometry 111. In addition, when the glue guiding features are configured as convex features, the glue guiding features may also slow down a flow of the adhesive glue 130. As can be seen, due to the glue guiding features, a track of adhesive glue 130 can be controlled by the adhesive geometry 111.

Furthermore, as more as the adhesive glue 130 moves over the ridge of the adhesive geometry 111, a volume of the closed cavity 150 increases, and this eventually compensates for the increasing air pressure inside the closed cavity 150. Therefore, the adhesive glue 130 can be prevented from suffering exploding.

Step S5, the adhesive glue 130 is cured when a final height of the top wafer 101 is obtained to form a wafer assembly 200.

In step S5, when a final height of the top wafer 101 is obtained, that is, the closed cavity 150 between the top wafer unit 120 and the bottom wafer unit 110 has a desired height, the lens unit 112 on the bottom wafer unit 110 is received in the closed cavity 150 and fully sealed by the adhesive glue 130. In this circumstance, the adhesive glue 130 is ready for curing, and then, a curing process can be further implemented to the adhesive glue 130 to make the adhesive glue 130 hardened and become a sealing wall around the lens unit 112. After the curing process, a wafer assembly 200 is formed, in which the lens units 112 are independently sealed by the adhesive glue 130, as illustrated in FIG. 3E.

Step S6, the wafer assembly 200 is sliced into a plurality of sealed modules 100.

Referring to FIG. 3F, in step S6, a slicing process is implemented to the wafer assembly 200 obtained in step S5, so as to form a plurality of sealed module 100. Each of the sealed module 100 includes a bottom wafer unit 110 serving as a first substrate and having a lens unit 112 thereon, a top wafer unit 120 serving as a second substrate, and a sealing wall 130 arranged between the bottom wafer unit 110 and the top wafer unit 120 and around the lens unit 112 to form a closed cavity 150. The lens unit 112 is received in the closed cavity 150 and sealed by the sealing wall 130.

In the above-described method, the plurality of sealed modules 100 is integrally formed as a wafer assembly 200, and then the wafer assembly 200 is separated to obtain the sealed modules 100 by slicing process. Alternatively, in other embodiments, each of the sealed modules 100 may be separately formed by using steps as mentioned above.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sealed module, comprising:
a first substrate comprising a lens unit and an adhesive geometry formed around the lens unit;
a second substrate stacked onto the first substrate; and
a sealing wall for sealing the first substrate with the second substrate to form a closed cavity;
wherein the lens unit is located in the closed cavity; the adhesive geometry serves as an adhesive barrier, and comprises glue guiding features for controlling a track of adhesive glue during a stacking process between the first substrate and the second substrate.

2. The sealed module of claim 1, wherein the glue guiding features of the adhesive geometry are convex features or concave features.

3. The sealed module of claim 2, wherein the adhesive geometry comprises a line with a convex or concave cross section.

4. The sealed module of claim 3, wherein the adhesive geometry has a round-ring shape or rectangular-ring shape.

5. The sealed module of claim 1, wherein the adhesive geometry is pre-molded on the first substrate by molding process.

6. The sealed module of claim 1, wherein the adhesive geometry is made of cured adhesive material, and is dispensed and cured on the first substrate.

7. The sealed module of claim 1, wherein the adhesive glue serves as the sealing wall after being cured, and the adhesive geometry is located within and wrapped up by the sealing wall.

8. A method for making a sealed module, comprising steps of:
providing a bottom wafer with a plurality of bottom wafer units, each of the bottom wafer units comprising a lens unit, and an adhesive geometry formed around the lens unit and comprising glue guiding features;
dispensing adhesive glue onto the bottom wafer inside every adhesive geometry and around every lens unit;
providing a top wafer with a plurality of top wafer units aligned with the bottom wafer units of the bottom wafer respectively;
stacking the top wafer onto the bottom wafer to form a wafer assembly, wherein the adhesive glue moves over a ridge of the adhesive geometry and the glue guiding features of the adhesive geometry controls a track of the adhesive glue during stacking process; and
slicing the wafer assembly to obtain a plurality of sealed modules.

9. The method of claim 8, wherein each of the sealed modules comprises a bottom wafer unit serving as a first substrate, a top wafer unit serving as a second substrate, and a sealing wall formed by the adhesive glue after being cured; the lens unit on the bottom wafer unit is sealed by the sealing wall.

10. The method of claim 8, wherein the glue guiding features of the adhesive geometry are convex features or concave features.

11. The method of claim 10, wherein the adhesive geometry comprises a line with a convex or concave cross section.

12. The method of claim 11, wherein the adhesive geometry is pre-molded on the bottom wafer unit around the lens unit by molding process.

13. The method of claim 11, wherein the adhesive geometry is dispensed onto the bottom wafer unit around the lens unit, and then is cured by using ultraviolet flood exposure.

14. The method of claim 8, wherein the step of stacking the top wafer onto the bottom wafer comprises:
moving the top wafer towards the bottom wafer, so that each top wafer unit of the top wafer, a corresponding bottom wafer unit of the bottom wafer, and the adhesive glue cooperatively form a closed cavity; and
curing the adhesive glue when a final height of the top wafer is obtained.

15. The method of claim 14, wherein when the top wafer moves towards the bottom wafer, the top wafer unit compresses air in the a closed cavity to increase an air pressure inside the closed cavity, so as to enable the adhesive glue to move over the ridge of the adhesive geometry.

16. The method of claim 14, wherein a movement of the adhesive glue over the ridge of the adhesive geometry compensates for increasing of the air pressure inside the closed cavity.

17. The method of claim 16, wherein the glue guiding features locally increase a surface area of the adhesive geometry and thereby locally decreasing surface energy of the adhesive geometry, so that the adhesive glue is attracted to move to the glue guiding features the adhesive geometry when the top wafer moves towards the bottom wafer.

18. The method of claim 17, wherein the glue guiding features are convex features further configured for slowing down a flow of the adhesive glue.

19. A method for making a sealed module, comprises steps of:
providing a first substrate comprising a lens unit and an adhesive geometry with glue guiding feature formed around the lens unit;
dispensing adhesive glue onto the first substrate inside the adhesive geometry and around the lens unit;
providing a second substrate and aligning the second substrate with the first substrate;
stacking the second substrate onto the first substrate to form the sealed module, wherein the adhesive glue moves over a ridge of the adhesive geometry and the glue guiding features of the adhesive geometry controls a track of the adhesive glue during stacking process.

20. The method of claim 19, wherein the glue guiding features of the adhesive geometry are convex features or concave features, and the adhesive geometry is formed on the first substrate by molding process or dispensing and curing process.
